(19) United States
(12) Patent Application Publication
(10) Pub. No.: US 2015/0376453 A1
(43) Pub. Date: Dec. 31, 2015

(54) ORGANIC POLYSILOXANE COMPOSITION, ENCAPSULANT, AND ELECTRONIC DEVICE

(71) Applicant: SAMSUNG SDI CO., LTD., Yongin-si (KR)

(72) Inventors: Ji-Ho LEE, Suwon-si (KR); Woo-Han KIM, Suwon-si (KR); Sang-Ran KOH, Suwon-si (KR); Hong-Jung YOO, Suwon-si (KR)

(21) Appl. No.: 14/585,905

(22) Filed: Dec. 30, 2014

(30) Foreign Application Priority Data
Jun. 30, 2014 (KR) 10-2014-0081300

(51) Int. Cl. C09D 183/04; C08L 83/04

(52) U.S. Cl. CPC C09D 183/04; C08L 83/04

(57) ABSTRACT

A curable organic polysiloxane composition includes (A) an amide compound represented by Chemical Formula 1, (B) at least one first siloxane compound including a silicon-bonded alkenyl group (Si-Vi) and including a moiety represented by Chemical Formula 2, and (C) at least one second siloxane compound having a silicon-bonded hydrogen (Si—H):

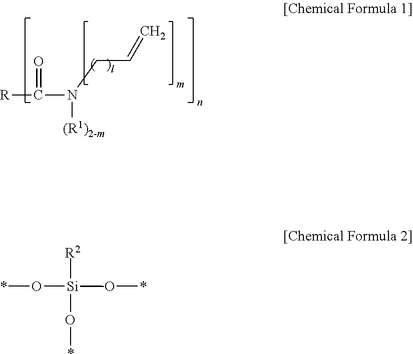

where R, R¹, R², l, m, and n are as defined in the specification.

### CROSS-REFERENCE TO RELATED APPLICATION

Korean Patent Application No. 10-2014-0081300, filed on Jun. 30, 2014, in the Korean Intellectual Property Office, and entitled: “Composition of Organic Polysiloxane, Encapsulant, and Electronic Device,” is incorporated by reference herein in its entirety.

### BACKGROUND

1. Field

Embodiments relate to a curable organic polysiloxane composition, an encapsulant and an electronic device including the encapsulant.

2. Description of the Related Art

A light emitting device such as a light emitting diode (LED), an organic light emitting device (OLED), a photoluminescent (PL) device, or the like, has been variously applied to a domestic electric device, a lighting device, a display device, various automatic devices, and the like.

The light emitting device may display intrinsic colors, such as blue, red, and green, of a light emitting material in a light emission part, or may display white by combining light emitters displaying different colors.

### SUMMARY

Embodiments are directed to a curable organic polysiloxane composition including an amide compound represented by Chemical Formula 1, at least one first siloxane compound having a silicon-bonded alkenyl group (Si-Vi) and including a moiety represented by Chemical Formula 2, and at least one second siloxane compound having a silicon-bonded hydrogen (Si—H):

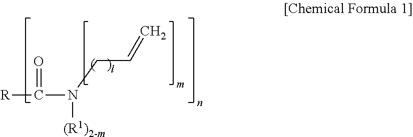

In Chemical Formula 1, R is a saturated or unsaturated linear or branched C1 to C30 aliphatic hydrocarbon group, a substituted or unsubstituted C3 to C30 alicyclic hydrocarbon group, or a substituted or unsubstituted C6 to C30 aromatic organic group, the C6 to C30 aromatic organic group being an aromatic mono-ring, a condensed ring of two or more aromatic rings, a condensed ring of at least one aromatic ring and at least one aliphatic ring, at least one aromatic ring bonded with at least one aliphatic hydrocarbon group, or two or more aromatic rings linked by a functional group selected from a single bond, —O—, —C(═O)—, —NH—, or —S(═O)₂—, R¹ is hydrogen or a C1 to C30 alkyl group, l is an integer of 1 to 30, m is 1 or 2, and n is an integer of 1 to 30.

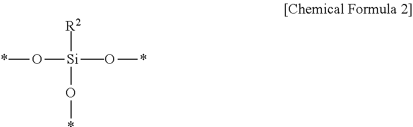

In Chemical Formula 2, R² is a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C2 to C30 alkynyl group, a substituted or unsubstituted C1 to C30 alkoxy group, a halogen, or a combination thereof.

In Chemical Formula 1, R may be a linear or branched C1 to C30 alkyl group, a C3 to C30 cycloalkyl group, a phenyl group, a naphthyl group, an anthracenyl group, a phenanthrenyl group, an indenyl group, an indanyl group, a biphenylene group, or an O,O-bisdiphenylene ether group.

In Chemical Formula 1, l may be an integer of 1 to 30.

In Chemical Formula 1, l may be 1.

In Chemical Formula 1, m may be 2.

In Chemical Formula 1, n may be an integer of 1 to 12.

The first siloxane compound may be represented by Chemical Formula 3:

(R⁷R⁸R⁹SiO_{1/2})_{M1}(R¹⁰R¹¹SiO_{2/2})_{D3}(R¹²SiO_{3/2})_{T1}(SiO_{3/2}—Y³—SiO_{3/2})_{T2}(SiO_{4/2})_{Q1} [Chemical Formula 3]

In Chemical Formula 3, R⁷ to R¹² are independently hydrogen, a hydroxy group, a halogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C3 to C30 heteroaryl group, a substituted or unsubstituted C2 to C30 alkenyl group, a substituted or unsubstituted C2 to C30 alkynyl group, a substituted or unsubstituted C1 to C30 alkoxy group, R²⁶(C═O)— (wherein R²⁶ is a substituted or unsubstituted C1 to C20 alkyl group, a substituted or unsubstituted C3 to C30 cycloalkyl group, a substituted or unsubstituted C6 to C30 aryl group, or a substituted or unsubstituted C7 to C30 arylalkyl group), or a combination thereof, at least one of R⁷ to R¹² is a substituted or unsubstituted C2 to C30 alkenyl group, Y³ is a single bond, a substituted or unsubstituted C1 to C20 alkylene group, a substituted or unsubstituted C3 to C20 cycloalkylene group, a substituted or unsubstituted C6 to C20 arylene group, a substituted or unsubstituted C2 to C20 heteroarylene group, a substituted or unsubstituted C2 to C20 alkenylene group, a substituted or unsubstituted C2 to C20 alkynylene group, or a combination thereof, 0<M1<1, 0≦D3<1, 0<T1<1, 0≦T2<1, 0≦Q1<1, and M1+D3+T1+T2+Q1=1.

The second siloxane compound may be represented by Chemical Formula 4:

(R¹⁵R¹⁶R¹⁷SiO_{1/2})_{M2}(R¹⁸R¹⁹SiO_{2/2})_{D4}(R²⁰SiO_{3/2})_{T3}(SiO_{3/2}—Y⁴—SiO_{3/2})_{T4}(SiO_{4/2})_{Q2} [Chemical Formula 4]

In Chemical Formula 4, R¹⁵ to R²⁰ are independently hydrogen, a hydroxy group, a halogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C3 to C30 heteroaryl group, a substituted or unsubstituted C2 to C30 alkenyl group, a substituted or unsubstituted C2 to C30 alkynyl group, a substituted or unsubstituted C1 to C30 alkoxy group, R²⁷(C═O)— (wherein R²⁷ is a substituted or unsubstituted C1 to C20 alkyl group, a substituted or unsubstituted C3 to C30 cycloalkyl group, a substituted or unsubstituted C6 to C30 aryl group, or a substituted or unsubstituted C7 to C30 arylalkyl group), or a combination thereof, at least one of R¹⁵ to R²⁰ is hydrogen, Y⁴ is a single bond, a substituted or unsubstituted C1 to C20 alkylene group, a substituted or unsubstituted C3 to C20 cycloalkylene group, a substituted or unsubstituted C6 to C20 arylene group, a substituted or unsubstituted C2 to C20 heteroarylene group, a substituted or unsubstituted C2 to C20 alkenylene group, a substituted or unsubstituted C2 to C20 alkynylene group, or a combination thereof, 0<M2<1, 0≦D4<1, 0≦T3<1, 0≦T4<1, 0≦Q2<1, and M2+D4+T3+T4+Q2=1.

At least one of R⁷ to R¹² may be a substituted or unsubstituted C6 to C30 aryl group.

At least one of R¹⁵ to R²⁰ may be a substituted or unsubstituted C6 to C30 aryl group.

The amide compound represented by Chemical Formula 1 may be included in an amount of less than or equal to about 5 wt % based on the total amount of the first siloxane compound and the second siloxane compound.

The amide compound represented by Chemical Formula 1 may be included in an amount of about 0.1 wt % to about 5 wt % based on the total amount of the first siloxane compound and the second siloxane compound.

The first siloxane compound may be included in an amount of greater than about 50 wt % based on the total amount of the first siloxane compound and the second siloxane compound. The second siloxane compound may be included in an amount of about 50 wt % or less based on the total amount of the first siloxane compound and the second siloxane compound.

The amide compound represented by Chemical Formula 1 may be one of the following compounds:

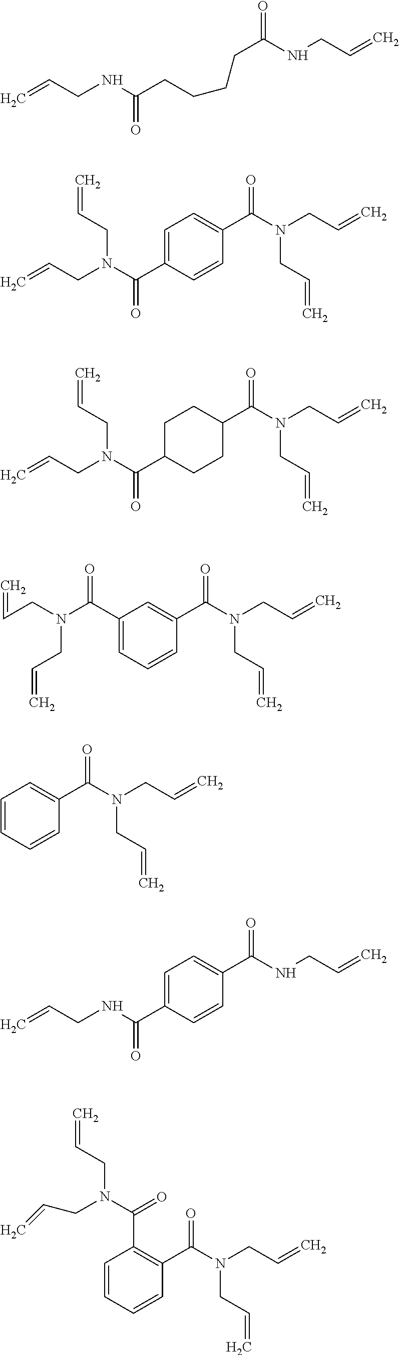

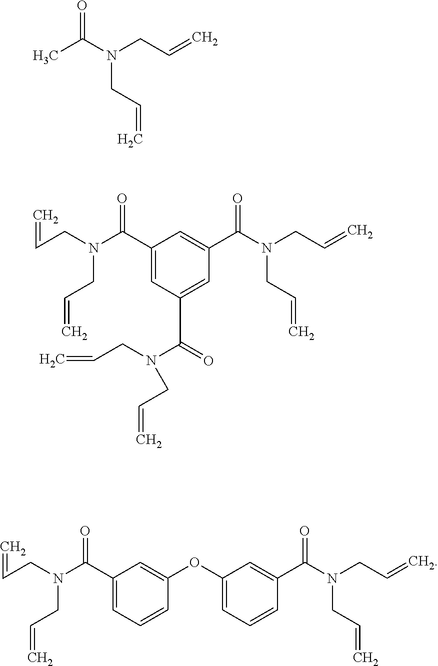

Embodiments are also directed to an encapsulant obtained by curing the curable organic polysiloxane composition.

Embodiments are also directed to an electronic device including the encapsulant.

### BRIEF DESCRIPTION OF THE DRAWINGS

Features will become apparent to those of skill in the art by describing in detail exemplary embodiments with reference to the attached drawings in which:

FIG. 1 illustrates a schematic cross-sectional view showing a light emitting diode according to an embodiment.

FIG. 2 illustrates a ¹H-NMR graph of N,N-diallyl benzamide according to Synthesis Example 2-1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawing figures, the dimensions of layers and regions may be exaggerated for clarity of illustration.

As used herein, when a definition is not otherwise provided, the term “substituted” may refer to one substituted with at least a substituent selected from a halogen (F, Br, Cl, or I), a hydroxy group, an alkoxy group, a nitro group, a cyano group, an amino group, azido group, an amidino group, a hydrazino group, a hydrazono group, a carbonyl group, a carbamyl group, a thiol group, ester group, a carboxyl group or a salt thereof, a sulfonic acid group or a salt thereof, a phosphoric acid or a salt thereof, a C1 to C30 alkyl group, a C2 to C30 alkenyl group, a C2 to C30 alkynyl group, a C6 to C30 aryl group, a C7 to C30 arylalkyl group, a C1 to C30 alkoxy group, a C1 to C30 heteroalkyl group, a C3 to C30 heteroarylalkyl group, a C3 to C30 cycloalkyl group, a C3 to C30 cycloalkenyl group, a C6 to C30 cycloalkynyl group, a C3 to C30 heterocycloalkyl group, and a combination thereof, instead of hydrogen of a compound.

As used herein, when a definition is not otherwise provided, the term “hetero” may refer to one including 1 to 3 heteroatoms selected from N, O, S, and P.

Hereinafter, an encapsulant composition according to an embodiment is described.

In an embodiment, a curable polysiloxane composition may include (A) an amide compound represented by Chemical Formula 1, (B) at least one kind of a first siloxane compound having a silicon-bonded alkenyl group (Si-Vi) and including a moiety represented by Chemical Formula 2, and (C) at least one kind of a second siloxane compound having a silicon-bonded hydrogen (Si—H):

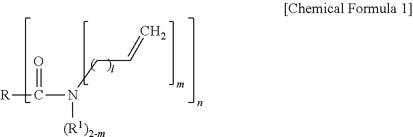

In Chemical Formula 1,

R is a saturated or unsaturated linear or branched C1 to C30 aliphatic hydrocarbon group, a substituted or unsubstituted C3 to C30 alicyclic hydrocarbon group, or a substituted or unsubstituted C6 to C30 aromatic organic group, wherein the C6 to C30 aromatic organic group is an aromatic mono-ring, a condensed ring of two or more aromatic rings, a condensed ring of at least one aromatic ring and at least one aliphatic ring, at least one aromatic ring bonded with at least one aliphatic hydrocarbon group, or two or more aromatic rings linked by a functional group selected from a single bond, —O—, —C(═O)—, —NH—, or —S(═O)₂—,

R¹ is hydrogen or a C1 to C30 alkyl group,

l is an integer of 1 to 30,

m is 1 or 2, and

n is an integer of 1 to 30.

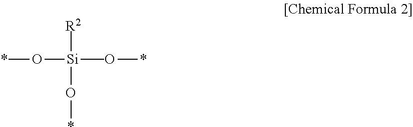

In Chemical Formula 2,

R² is a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C2 to C30 alkynyl group, a substituted or unsubstituted C1 to C30 alkoxy group, a halogen, or a combination thereof.

A light emitting diode (LED) may have advantages of energy efficiency, long life-span, a high speed response, or the like, compared with a conventional light emitting source and thus, may be commercially available for a general lighting as well as for a portable phone or an LCD backlight. A white LED has been developed to provide high luminance/high emission. In this case, conventional epoxy having poor heat resistance has been replaced by a silicon material.

An LED may include a package including a housing for mechanical protection, a LED chip, a phosphor, an adhesive, an encapsulant, a heat-resistant part and the like, to emit light, For example, the LED chip may be wrapped with an encapsulant. The chip generates light energy, of which about 15% may be emitted as light, while the rest of the light energy may be absorbed in the encapsulant or the like. An LED having high luminance/high emission may be operated at a high temperature. Accordingly, it is desirable for the encapsulant to have heat resistance. In addition, it is desirable for the encapsulant to have high yellowing resistance against short wavelength light having high energy and also, to have small moisture absorption, resistance to sulfur, and a low coefficient of thermal expansion. Furthermore, it is desirable for the encapsulant to have a higher refractive index than that of the LED chip, such that LED light may be ejected out of the chip without total reflection on the interface between the encapsulant and the chip. It is also desirable for the encapsulant to have high thermal conductivity, since improvement through a heat management design using a heat dissipating plate or the like in the package is limited. Accordingly, a conventional epoxy resin having low heat resistance and high moisture absorption and a tendency to yellowing by short wavelength light may be suitable for a low emission but may be replaced by a silicon material for a higher emission of white light. Regarding other materials, a ceramic or metal air-tight encapsulant may be advantageous against a pressure and moisture but may be inappropriate for mass production.

Therefore, embodiments may provide an organic polysiloxane composition of high luminance that may secure stability of a light emitting device by remarkably improving crack resistance as well as maintaining high heat and light resistances and also, improving processability by improving sulfur resistance and decreasing stickiness.

The organic polysiloxane composition according to the embodiment includes a curable polysiloxane compound including a three dimensional reticular structural unit represented by Chemical Formula 2, and an amide compound represented by Chemical Formula 1.

If a siloxane compound having a three-dimensional reticular structure is used by itself to prepare a curable organic polysiloxane composition for an encapsulant in order to increase hardness of the composition during the curing due to the dense structure of the compound and to improve sulfur resistance, water resistance and the like of an encapsulant manufactured by using the composition, the resultant encapsulant may have a tendency to crack on the surface at a high temperature. For example, the room temperature modulus is not only increased but its high temperature modulus is also high. Accordingly, the siloxane compound having a three-dimensional reticular structure may only be used in a limited amount to improve sulfur resistance or the like of an encapsulant.

However, a curable organic polysiloxane composition including the amide compound represented by Chemical Formula 1 according to embodiments may have a high room temperature modulus but a decreased high temperature modulus. Thus the curable organic polysiloxane composition according to embodiments may address issues of crack formation of an encapsulant at a high temperature, while the encapsulant maintains sulfur resistance, water resistance, or the like.

Without being bound to specific theory, the above effect may be obtained by the structural characteristics of the amide compound represented by Chemical Formula 1 in the compositions of the embodiments, which improve packing properties of the siloxane compounds forming curable organic polysiloxane in the composition and somewhat provide flexibility among the packed siloxane compounds.

The amide compound represented by Chemical Formula 1 may have a structure that an amide group moiety forms a planar structure, and the residual groups of the amide groups may be fixed along therewith. Accordingly, a double bond moiety of an allyl group at the terminal end of the amide residual groups may be cross-linked with the second siloxane compound having the silicon-bonded hydrogen (Si—H), and thus may build a stereospecific spatial arrangement in the cross-linked polyorganosiloxane to cure the composition. Accordingly, the composition may have an excellent tensile strength and elastic modulus. The composition may provide a cured product having high hardness and high luminance. The cured product may also have high crack resistance and interface adherence.

When R in Chemical Formula 1 is a C6 to C30 aromatic group, the R group may form an extended planar structure with the amide residual groups, and thus may fix overall the residual groups of the Chemical Formula 1. As a result, packing properties of the cross-linked polyorganosiloxane may be improved.

When the R in Chemical Formula 1 is not an aromatic group, but instead is a monovalent or divalent C1 to C30 aliphatic hydrocarbon group or a monovalent or tetravalent C3 to C30 alicyclic hydrocarbon group, the amide groups bonded with the aliphatic hydrocarbon group or alicyclic hydrocarbon group in Chemical Formula 1 are not completely fixed, but are still considerably limited in mobility. Accordingly, the stereospecific spatial arrangement of the cross-linked polyorganosiloxane may be maintained.

Although the amide group and the other groups bonded therewith in the compound of Chemical Formula 1 are somewhat fixed, the structure of the compound may be not totally fixed but partly flexible. Accordingly, the curable organic polysiloxane composition including the compound represented by Chemical Formula 1 may have a packing property to a degree due to the compound represented by Chemical Formula 1, but also may have flexibility through the residual groups of the compound. This flexibility may provide a decreased high temperature modulus of the curable polysiloxane composition including the compound of Chemical Formula 1, while the composition still has a high room temperature modulus. For example, high temperature characteristics of an encapsulant manufactured by curing the composition, such as crack resistance at a high temperature, or impact resistance at a high temperature may be remarkably improved due to the decreased high temperature modulus.

If a cured encapsulant has a sticky surface, mass production of the encapsulant may be interrupted and an operation rate may deteriorate. Accordingly, excellent mass production processability may be obtained by effectively decreasing the surface adhesiveness of an encapsulant. The composition including the compound represented by Chemical Formula 1 may provide increased heat resistance at a high temperature, and may decrease the surface stickiness of an encapsulant manufactured by using the composition.

The curable organic polysiloxane composition according to embodiments may maintain a high refractive index, high luminescence characteristics and the like of a general organic polysiloxane composition but may have much improved high temperature heat resistance, high temperature impact resistance and sulfur resistance and also, remarkably improved processability due to the decreased surface stickiness.

Hereinafter, amide compounds represented by Chemical Formula 1 are described.

In Chemical Formula 1, R may be a linear or branched C1 to C30 alkyl group, a C3 to C30 cycloalkyl group, a phenyl group, a naphthyl group, an anthracenyl group, a phenanthrenyl group, an indenyl group, an indanyl group, a biphenylene group, or an O,O-bisdiphenylene ether group.

In Chemical Formula 1, l may be an integer of 1 to 10, and n may be an integer of 1 to 12.

In Chemical Formula 1, when n is 1 to 12, each residual group containing an amide group may be bonded at any position of R. In addition, the residual groups containing an amide group may be symmetrically positioned around R as a center. For example, when the R is a phenyl group, and the n is 3, each amide residual group may be respectively bonded at the positions 1, 3, and 5 of the phenyl group. Or, when the R is a cyclohexyl group, and the n is 2, each amide residual group may be respectively bonded at the positions 1 and 4 of the cyclohexyl group.

The amide compound represented by Chemical Formula 1 may bond with the silicon-bonded hydrogen (Si—H) of the second siloxane compound and may cross-link more than two second siloxane compounds. When m in Chemical Formula 1 is 1, n may be an integer greater than or equal to about 2.

In Chemical Formula 1, l may be 1.

In Chemical Formula 1, when the l is 1, a distance between a nitrogen atom in the amide residual group and a vinyl group at the terminal end of the amide residual group is shorter, and position mobility among these groups may be smaller. Accordingly, the amide compound represented by Chemical Formula 1 may provide improved packing properties of an organic polysiloxane composition prepared by using it, and thus may sufficiently form a stereospecific spatial arrangement.

For example, the amide compound represented by Chemical Formula 1 may be one of the following compounds:

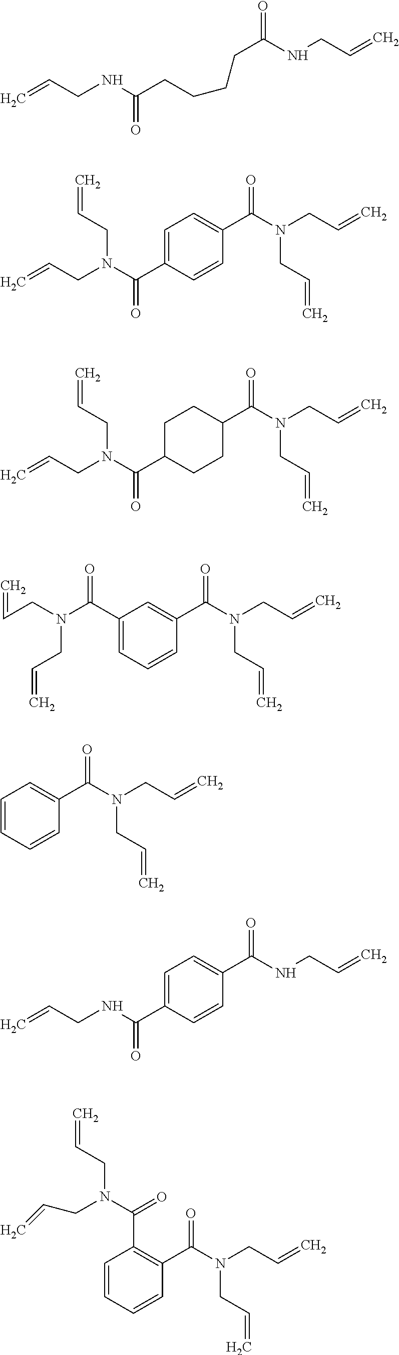

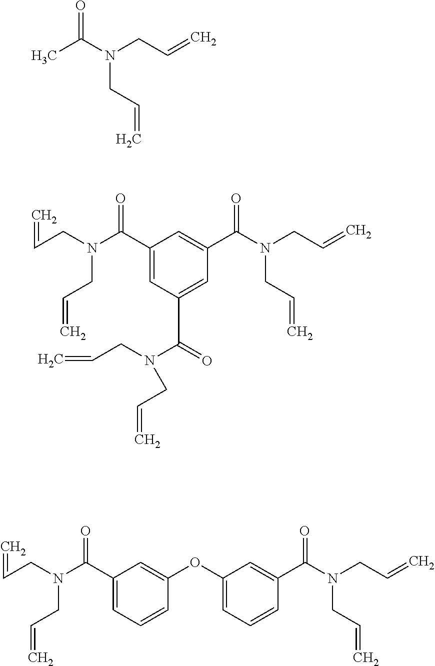

The first siloxane compound may be a compound represented by Chemical Formula 3:

(R⁷R⁸R⁹SiO_{1/2})_{M1}(R¹⁰R¹¹SiO_{2/2})_{D3}(R¹²SiO_{3/2})_{T1}(SiO_{3/2}—Y³—SiO_{3/2})_{T2}(SiO_{4/2})_{Q1} [Chemical Formula 3]

In Chemical Formula 3,

R⁷ to R¹² are independently hydrogen, a hydroxy group, a halogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C3 to C30 heteroaryl group, a substituted or unsubstituted C2 to C30 alkenyl group, a substituted or unsubstituted C2 to C30 alkynyl group, a substituted or unsubstituted C1 to C30 alkoxy group, R²⁶(C═O)— (wherein R²⁶ is a substituted or unsubstituted C1 to C20 alkyl group, a substituted or unsubstituted C3 to C30 cycloalkyl group, a substituted or unsubstituted C6 to C30 aryl group, or a substituted or unsubstituted C7 to C30 arylalkyl group), or a combination thereof,

at least one of R⁷ to R¹² includes a substituted or unsubstituted C2 to C30 alkenyl group,

Y³ is a single bond, a substituted or unsubstituted C1 to C20 alkylene group, a substituted or unsubstituted C3 to C20 cycloalkylene group, a substituted or unsubstituted C6 to C20 arylene group, a substituted or unsubstituted C2 to C20 heteroarylene group, a substituted or unsubstituted C2 to C20 alkenylene group, a substituted or unsubstituted C2 to C20 alkynylene group, or a combination thereof,

0<M1<1, 0≦D3<1, 0<T1<1, 0≦T2<1, 0≦Q1<1, and

M1+D3+T1+T2+Q1=1.

At least one of the R⁷ to R¹² may include a substituted or unsubstituted C6 to C30 aryl group.

The first siloxane compound may be a compound having a silicon-bonded alkenyl group (Si-Vi), and may include, for example, an average of two or more silicon-bonded alkenyl group (Si-Vi) per molecule. The silicon-bonded alkenyl group (Si-Vi) may react with the silicon-bonded hydrogen (Si—H) of the second siloxane compound having silicon-bonded hydrogen (Si—H).

The first siloxane compound may be obtained by hydrolysis and condensation polymerization of at least one selected from, for example, a monomer represented by R⁷R⁸R⁹SiZ¹, a monomer represented by R¹⁰R¹¹SiZ²Z³, a monomer represented by R¹²SiZ⁴Z⁵Z⁶, a monomer represented by Z⁷Z⁸Z⁹Si—Y³—SiZ¹⁰Z¹¹Z¹², and a monomer represented by SiZ¹³Z¹⁴Z¹⁵Z¹⁶. Herein, R⁷ to R¹² are the same as defined above, and Z¹ to Z¹⁶ are independently C1 to C30 alkoxy group, a hydroxy group, a halogen, a carboxyl group, or a combination thereof.

At least one of the R⁷ to R¹² may include a substituted or unsubstituted C6 to C30 aryl group. Accordingly, optical properties may be secured by increasing a refractive index.

One or more kinds of the first siloxane compound may be used.

The second siloxane compound may be represented by Chemical Formula 4.

(R¹⁵R¹⁶R¹⁷SiO_{1/2})_{M2}(R¹⁸R¹⁹SiO_{2/2})_{D4}(R²⁰SiO_{3/2})_{T3}(SiO_{3/2}—Y⁴—SiO_{3/2})_{T4}(SiO_{4/2})_{Q2} [Chemical Formula 4]

In Chemical Formula 4,

R¹⁵ to R²⁰ are independently hydrogen, a hydroxy group, a halogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C3 to C30 heteroaryl group, a substituted or unsubstituted C2 to C30 alkenyl group, a substituted or unsubstituted C2 to C30 alkynyl group, a substituted or unsubstituted C1 to C30 alkoxy group, R²⁷(C═O)— (wherein R²⁷ is a substituted or unsubstituted C1 to C30 alkyl group, a substituted or unsubstituted C3 to C30 cycloalkyl group, a substituted or unsubstituted C6 to C30 aryl group, or a substituted or unsubstituted C7 to C30 arylalkyl group), or a combination thereof,

at least one of R¹⁵ to R²⁰ includes hydrogen,

Y⁴ is a single bond, a substituted or unsubstituted C1 to C20 alkylene group, a substituted or unsubstituted C3 to C20 cycloalkylene group, a substituted or unsubstituted C6 to C20 arylene group, a substituted or unsubstituted C2 to C20 heteroarylene group, a substituted or unsubstituted C2 to C20 alkenylene group, a substituted or unsubstituted C2 to C20 alkynylene group, or a combination thereof,

0<M2<1, 0≦D4<1, 0≦T3<1, 0≦T4<1, 0≦Q2<1, and

M2+D4+T3+T4+Q2=1.

At least one of the R¹⁵ to R²⁰ may include a substituted or unsubstituted C6 to C30 aryl group.

The second siloxane compound may be a compound having silicon-bonded hydrogen (Si—H), and may include, for example, an average of two or more silicon-bonded hydrogen (Si—H) per a molecule. The silicon-bonded hydrogen (Si—H) may react with the silicon-bonded alkenyl group of the first siloxane compound.

The second siloxane compound may be obtained by hydrolysis and condensation polymerization of at least one selected from, for example, a monomer represented by R¹⁵R¹⁶R¹⁷SiZ¹⁷, a monomer represented by R¹⁸R¹⁹SiZ¹⁸Z¹⁹, a monomer represented by R²⁰siZ²⁰Z²¹Z²², a monomer represented by Z²³Z²⁴Z²⁵Si—Y⁴—SiZ²⁶Z²⁷Z²⁸, and a monomer represented by SiZ²⁹Z³⁰Z³¹Z³². Herein, R¹⁵ to R²⁰ are the same as defined above, and Z¹⁷ to Z³² are independently a C1 to C30 alkoxy group, a hydroxy group, a halogen, a carboxyl group, or a combination thereof.

At least one of the R¹⁵ to R²⁰ may include a substituted or unsubstituted C6 to C30 aryl group. Accordingly, desired optical properties may be provided by increasing the refractive index.

The first polysiloxane and the second polysiloxane may undergo a hydrosilylation reaction. A high molecular weight and dense polysiloxane structure may be provided when the composition is cured, protecting a light emitting device from external moisture and gases.

The first siloxane compound and the second siloxane compound may each have a weight average molecular weight of about 100 g/mol to about 30,000 g/mol.

The first siloxane compound may be included in an amount of greater than about 50 wt % based on the total amount of the first siloxane compound and the second siloxane compound, and the second siloxane compound may be included in an amount of less than about 50 wt % based on the total amount of the first siloxane compound and the second siloxane compound.

The curable organic polysiloxane composition may further include at least one third siloxane compound having a similar structure to that of the first siloxane compound but not including a structure represented by Chemical Formula 2 and including a silicon-bonded alkenyl group. The third siloxane compound may be represented by Chemical Formula 5:

(R²¹R²²R²³SiO_{1/2})_{M3}(R²⁴R²⁵SiO_{2/2})_{D5}(SiO_{3/2}—Y⁵—SiO_{3/2})_{T5}(SiO_{4/2})Q₃ [Chemical Formula 5]

In Chemical Formula 5,

R²¹ to R²⁵ are independently hydrogen, a hydroxy group, a halogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C32 to C30 heteroaryl group, a substituted or unsubstituted C2 to C30 alkenyl group, a substituted or unsubstituted C2 to C30 alkynyl group, a substituted or unsubstituted C1 to C30 alkoxy group, R²⁸(C═O)— (wherein R²⁸ is a substituted or unsubstituted C1 to C20 alkyl group, a substituted or unsubstituted C3 to C30 cycloalkyl group, a substituted or unsubstituted C6 to C30 aryl group, or a substituted or unsubstituted C7 to C30 arylalkyl group), or a combination thereof,

at least one of R²¹ to R²⁵ includes a substituted or unsubstituted C2 to C30 alkenyl group,

Y⁵ is a single bond, a substituted or unsubstituted C1 to C20 alkylene group, a substituted or unsubstituted C3 to C20 cycloalkylene group, a substituted or unsubstituted C6 to C20 arylene group, a substituted or unsubstituted C2 to C20 heteroarylene group, a substituted or unsubstituted C2 to C20 alkenylene group, a substituted or unsubstituted C2 to C20 alkynylene group, or a combination thereof,

0<M3<1, 0<D5<1, O<T5<1, 0<Q5<1, and

M3+D3+T5+Q5=1.

At least one of the R²¹ to R²⁵ may include a substituted or unsubstituted C6 to C30 aryl group. Accordingly, desired optical properties may be provided by increasing a refractive index.

The third siloxane compound represented by Chemical Formula 5 may be prepared in the same method as that of preparing the first siloxane compound represented by the Chemical Formula 3 except for including no structure represented by Chemical Formula 2. The method of preparing the third siloxane compound represented by Chemical Formula 5 will not be repeated here.

When the third siloxane compound is additionally included, the total amount of the first siloxane compound and the third siloxane compound may be included in an amount of greater than about 50 wt % of the total amount of the first, second and third siloxane compounds, while the second siloxane compound may be included in an amount of less than about 50 wt % of the total amount of the first, second and third siloxane compounds.

The third siloxane compound may have a weight average molecular weight of about 100 g/mol to about 30,000 g/mol.

The composition may further include a hydrosilylation catalyst.

The hydrosilylation catalyst may promote the hydrosilylation reaction of the first siloxane compound and the second siloxane compound. The hydrosilylation catalyst may be, for example platinum, rhodium, palladium, ruthenium, iridium, or a combination thereof.

The amide compound represented by Chemical Formula 1 may be included in an amount of about 5 wt % or less based on the total amount of the siloxane compounds. For example, when the composition includes the first, second, and third siloxane compounds, the amide compound may be included in an amount of about 5 wt % or less based on the total amount of the first, second, and third siloxane compounds.

For example, the amide compound represented by Chemical Formula 1 may be included in an amount of about 0.1 wt % to about 5 wt %, for example, about 0.3 wt % to about 3 wt %, or, for example, about 0.5 wt % to about 2 wt %, based on the entire amount of the siloxane compounds.

When the amide compound represented by Chemical Formula 1 is included in an amount of more than 0.1 wt %, the composition may have a suitably decreased high temperature modulus. When the amide compound represented by Chemical Formula 1 is included in an amount of less than about 5 wt %, the composition may have suitable viscosity and may be easily curable.

The composition may be heat-treated and cured at a predetermined temperature, and thus, may be used as an encapsulant. The encapsulant may be applied to, for example, an electronic device such as a light emitting diode or an organic light emitting diode device.

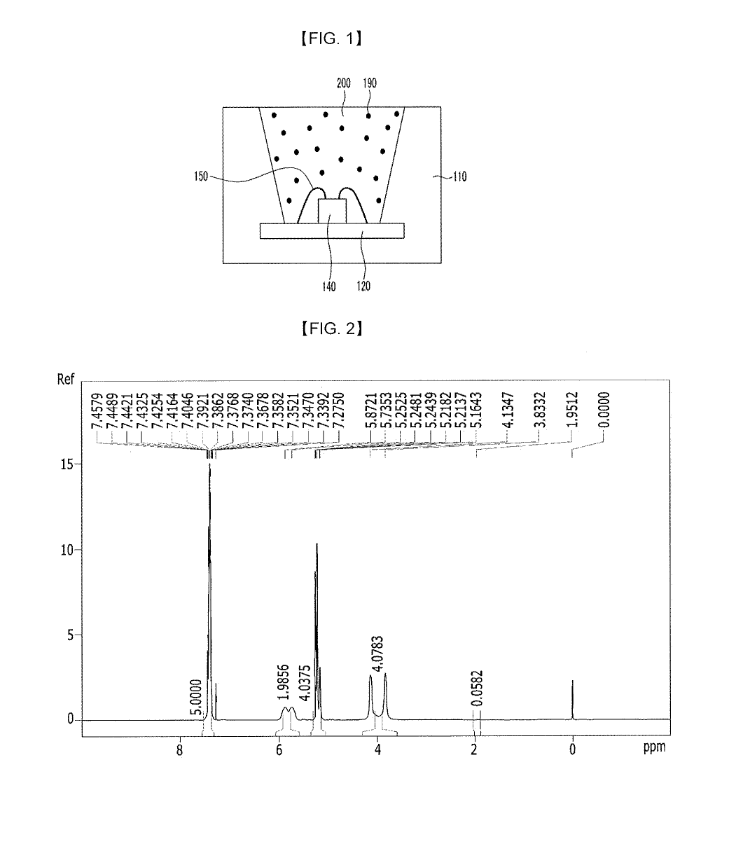

Hereinafter, a light emitting diode, as one example of an electronic device manufactured by applying an encapsulant according to one embodiment, is illustrated referring to FIG. 1.

FIG. 1 illustrates a schematic cross-sectional view of a light emitting diode according to an embodiment.

Referring to FIG. 1, the light emitting diode may include a mold 110, a lead frame 120 disposed inside the mold 110, a light emitting diode chip 140 mounted on the lead frame 120, a bonding wire 150 connecting the lead frame 120 to the light emitting diode chip 140, and an encapsulant 200 covering the light emitting diode chip 140.

The encapsulant 200 may be obtained by curing the composition according to embodiments. The encapsulant 200 may be formed from the composition, and thus, may help to protect the light emitting diode chip 140 effectively and prevent, or reduce the likelihood of, deterioration of the performance of the light emitting diode.

A phosphor 190 may be dispersed in the encapsulant 200. The phosphor 190 may include a material excited by light and emitting light within its intrinsic wavelength range. The phosphor may include a quantum dot such as a semiconductor nanocrystal. The phosphor 190 may include, for example, a mixture of two or more selected from a blue phosphor, a green phosphor, or a red phosphor.

The phosphor 190 may display a color in a predetermined wavelength region as induced by light supplied from the light emitting diode chip 140 as a light emitting source. The light emitting diode chip 140 may provide a color in a shorter wavelength region than the color displayed by the phosphor 190. For example, when the phosphor 190 displays red light, the light emitting diode chip 140 may provide blue or green light having a shorter wavelength region than the red light.

In addition, the color emitted from the light emitting diode chip 140 may be combined with the color emitted from the phosphor 190 and thus, the light emitting diode may display a white light. For example, when the light emitting diode chip 140 supplies blue light while the phosphor 190 includes a red phosphor and a green phosphor, the electronic device may combine blue, red, and green and display white light.

The phosphor 190 may be omitted.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLE

### Synthesis Example 1

### Preparation of Siloxane Compound

### (A) Synthesis of First Siloxane Compound Including Silicon-Bonded Alkenyl Group (Si-Vi) and T-Structure Siloxane Unit

Water and toluene were mixed in a weight ratio of 5:5 to obtain a mixed solvent, 1 kg of the mixed solvent was put in a 3-neck flask and maintained at 23° C., and a monomer mixture of dimethylvinyl chlorosilane and phenyltrichlorosilane in a mole ratio of 0.25:0.75 was added thereto in a dropwise fashion over 2 hours. When the addition was complete, the obtained mixture was heated and refluxed at 90° C. for 3 hours to perform a condensation polymerization reaction. Subsequently, the resultant was cooled down to room temperature, and an aqueous layer was removed therefrom, preparing a polymer solution dissolved in toluene. The obtained polymer solution was cleaned with water to remove a reaction byproduct, chlorine. Subsequently, the neutral polymer solution was distilled under a reduced pressure to remove the toluene, obtaining a first siloxane compound represented by the following Chemical Formula 6.

(ViMe₂SiO_{1/2})_{0.25}(PhSiO_{3/2})_{0.75} [Chemical Formula 6]

### (B) Synthesis of Second Siloxane Compound Including Silicon-Bonded Hydrogen (Si—H)

Water and toluene were mixed in a weight ratio of 5:5 to obtain a mixed solvent, 1 kg of the mixed solvent was put in a 3-neck flask and maintained at 23° C., and a monomer mixture of dimethylhysrodichlorosilane and diphenyldichlorosilane in a mole ratio of 0.67:0.33 was added thereto in a dropwise fashion over 2 hours. When the addition was complete, the obtained mixture was heated and refluxed at 90° C. for 3 hours to perform a condensation polymerization reaction. Subsequently, the resultant was cooled down to room temperature, an aqueous layer was removed therefrom, preparing a polymer solution dissolved in toluene. The obtained polymer solution was cleaned to remove chlorine of a byproduct from the reaction. Subsequently, the neutral polymer solution was distilled under a reduced pressure to remove the toluene, obtaining a second siloxane compound represented by the following Chemical Formula 7.

(Me₂HSiO_{1/2})_{0.67}(Ph₂SiO_{2/2})_{0.33} [Chemical Formula 7]

### (C) Synthesis of Third Siloxane Compound Including Silicon-Bonded Alkenyl Group (Si-Vi) and not Including T Structure Siloxane Unit

Water and toluene were mixed in a weight ratio of 5:5 to prepare a mixed solvent, 1 kg of the mixed solvent was put in a 3-neck flask and maintained at 23° C., and a monomer mixture of methylphenyl dichiorosilane and vinyldimethyl chlorosilane in a mole ratio of 0.955:0.045 was added thereto in a dropwise fashion over 2 hours. When the addition was complete, the obtained mixture was heated and refluxed at 90° C. for 3 hours to perform a condensation polymerization reaction. Subsequently, the resultant was cooled down to room temperature, and an aqueous layer was removed therefrom, preparing a polymer solution dissolved in toluene. The obtained polymer solution was cleaned with water to remove chlorine of a byproduct from the reaction. Subsequently, the neutral polymer solution was distilled under a reduced pressure to remove the toluene, obtaining a third siloxane compound represented by the following Chemical Formula 8.

(ViMe₂SiO_{1/2})_{0.45}(MePhSiO_{2/2})_{0.955} [Chemical Formula 8]

### Synthesis Example 2

### Preparation of Amide Compound

As for an amide compound, each compound represented by the following Chemical

Formulae 9 to 18 was manufactured or bought. Hereinafter, the chemical structure, manufacturing method or purchase source of each compound is provided.

### Synthesis Example 2-1

### N,N-diallyl Benzamide

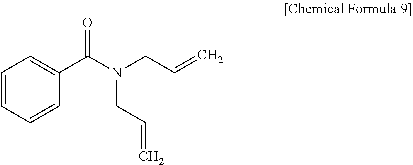

150 ml of anhydrous dichloro methane, 12.49 ml (88.92 mmol) of triethyl amine and 9.66 ml (78.25 mmol) of diallyl amine were put in a 3-necked flask (500 ml) equipped with a reaction agitator, a thermometer, and a cap made of rubber septum under a nitrogen atmosphere and agitated for about 20 minutes. The flask was dipped in an ice water bath and agitated, and then, 20 ml of dichloro methane dissolved in 8.26 ml (71.14 mmol) of benzoyl chloride was added thereto for about 1 hour. The reaction solution was fervently agitated for about 6 hours, while maintaining the temperature from about 5° C. to 10° C. After the agitation, 100 ml of a chloride ammonium aqueous solution was added thereto over about 20 minutes, the mixture was additionally agitated, and then, an organic layer was separated therefrom and cleaned twice with 100 ml of water and once with 50 ml of a saturated saline solution. The resultant was purified through silica gel column chromatography and three times recrystallized by using dichloro methane-normal hexane, obtaining 13.82 g (96%) of a colorless liquid of N,N-diallyl benzamide represented by the Chemical Formula 9. The obtained N,N-diallyl benzamide showed the following ¹H-NMR data:

¹H NMR (CHCl₃, 300 MHz) 7.45-33 (m, 5H), 5.87 (br s, 1H), 5.73 (br s, 1H), 5.25-5.16 (m, 4H), 4.13 (br s, 2H), 3.83 (br s, 2H). (The obtained ¹H-NMR spectrum of N,N-diallyl benzamide is reproduced in FIG. 2.)

### Synthesis Example 2-2

### Compound Represented by Chemical Formula 10

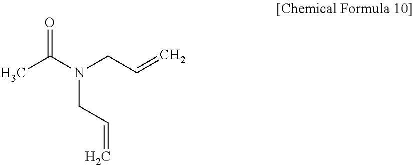

An amide compound represented by the Chemical Formula 10 was obtained according to the same method as Synthesis Example 2-1 except for using 5.05 ml (71.14 mmol) of acetyl chloride instead of 8.26 ml (71.14 mmol) of the benzoyl chloride.

### Synthesis Example 2-3

### Compound Represented by Chemical Formula 11

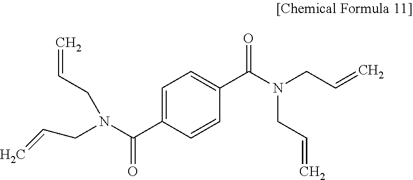 [SMILES: C=CCN(CC=C)C(=O)c1ccc(C(=O)N(CC=C)CC=C)cc1]

An amide compound represented by the Chemical Formula 11 was synthesized according to the same method as Synthesis Example 2-1 except for using 14.44 g (71.14 mmol) of terephthaloyl chloride instead of 8.26 ml (71.14 mmol) of the benzoyl chloride.

### Examples 1 to 3 and Comparative Example 1

### Preparation of Curable Organic Polysiloxane Composition and Light Emitting Device Using the Same

(1) Preparation of Curable Organic Polysiloxane Composition

The (A) first siloxane compound, the (B) second siloxane compound, and the (C) third siloxane compound according to Synthesis Example 1, and the N,N-diallyl benzamide represented by Chemical Formula 9 according to Synthesis Example 2-1 were mixed in the amounts provided in the following Table 1, Pt—CS 2.0 (made by Unicore) as a (D) hydrosilylation catalyst was added thereto in an amount of about 5 ppm based on the total weight of the siloxane compounds and the amide compound, and SURFYNOL (made by TCI) as a catalyst suppresser was respectively added thereto in an amount of 0.02 wt %, and then, the mixture was vacuum/foam-removed, preparing each curable organic polysiloxane composition according to Examples 1 to 3 and Comparative Example 1 as shown in Table 1 below.

(2) Manufacture of LED Package

The curable organic polysiloxane composition was coated on a mold (2.5 cm (width)×7.5 cm (length)×1 cm (thickness)) coated with TEFLON on an LED package by dispensing, and then, heated at 150° C. for 2 hours and cured, forming a cured product specimen. The organic polysiloxane composition was coated on the coated mold by using a syringe having a needle with a diameter of 1.0 mm and discharging the composition from the needle to fill the mold including a reflector. When the discharged composition was cured, the LED package was completed.

Hardness of the cured specimen in the mold of the LED package was measured by using Shore A. The measurement result is provided in the following Table 1.

TABLE 1

| Resin composition | | Ex. 1 | Ex. 2 | Ex. 3 | Comp. Ex. 1 |
|---|---|---|---|---|---|
| amide compound: Chemical Formula 9 | | 0.5 | 1.0 | 2.0 | — |
| compound (wt %) | | | | | |
| third siloxane compound (wt %) | | — | — | — | 2 |
| first siloxane compound (wt %) | | 74.5 | 73 | 71 | 71 |
| second siloxane compound (wt %) | | 25 | 26 | 27 | 27 |
| Pt catalyst (ppm) | | 5 | 5 | 5 | 5 |
| catalyst suppresser, SURFYNOL (TCI) | | 0.02 | 0.02 | 0.02 | 0.02 |
| (wt %) | | | | | |
| hardness (Shore-A) | | 100 | 100 | 100 | 100 |
| refractive index | | 1.53 | 1.53 | 1.53 | 1.53 |
| initial T % | | 100.0 | 100.0 | 100.0 | 100.0 |
| high temperature heat resistance T % @450 nm | | 91.0 | 94.7 | 94.6 | 90.0 |
| (@150° C. * 1000 hr) | | | | | |
| Modulus (Mpa) 125° C. | | 2.9 | 2.9 | 2.5 | 5.2 |
| thermal impact | 400 cycles | pass | pass | pass | Pass |
| | 800 cycles | pass | pass | pass | fail |

In Table 1, refractive index and transmittance of each composition and modulus and thermal impact characteristics of a cured product when each composition was cured were measured in the following method.
Refractive Index: Refractive index of a liquid mixture before curing was measured by using an Abbe refractive index measuring instrument at D-line (589 nm) wavelength.
Transmittance: Light transmittance at a wavelength of 450 nm was measured by using an UV-spectrophotometer (UV-3600, Shimazu Corp.) after putting a cured light transmittance resin in a 10 mm-thick cell in order to evaluate heat resistance of a cured product.
Modulus: Mₚₐ and T_{g} were measured with a TA Instruments Dynamic Mechanical Analyzer (DMA Q800) to obtain modulus of the cured product.
Thermal Impact Characteristics: Thermal impact characteristics of an LED package were evaluated by operating the LED package at −45° C. to 125° C. for 400 cycles and 800 cycles and examining whether the surface of the LED package was cracked.

As shown from Table 1, the compositions of Example and Comparative Example all showed a refractive index of greater than or equal to 1.5, which is appropriate for an encapsulant composition.

In addition, as shown in Table 1, the organic polysiloxane composition including an amide compound along with a siloxane compound having a T structure according to the embodiment showed excellent high temperature heat resistance and a low modulus at a high temperature compared with the organic polysiloxane composition including no amide compound according to Comparative Example 1. Example 2 including an amide compound in an amount twice as much as that of Example 1 showed the same modulus and a remarkably improved effect in terms of heat resistance at a high temperature. In addition, Example 3 including an amide compound in an amount twice as much as that of Example 2 showed almost the same heat resistance at a high temperature but much improved modulus.

The allyl amide compound in the composition according to the embodiment may be a cross-linking agent having an amide structure and having a double bond at the terminal end. The allyl amide compound may provide a stereospecific spatial arrangement in an organic polysiloxane having a three-dimensional reticular structure, and thus may form a cured product having excellent tensile strength and elasticity, high hardness, and high luminance. In addition, the cured product may have excellent adherence. This cured product may be appropriate for an encapsulant and an electronic device including the encapsulant.

Each LED package manufactured by using the compositions according to the Examples and Comparative Example effectively operated without a crack and the like on the surface after 400 cycles operated at −45° C. to 125° C. However, when the LED packages using compositions according to the Examples and Comparative Example were operated for 800 cycles operated at the same temperature, the packages according to Examples 1 to 3 showed no crack and the like, but the LED package according to Comparative Example 1 showed a crack on the surface.

The LED package manufactured by using the compositions according to Example and Comparative Example were not sticky on the surface.

By way of summation and review, a light emitting device may generally include an encapsulant having a packaging or encapsulation structure. The encapsulant may protect the light emitting device from external gas and moisture and externally transmit light at various wavelengths emitted from the light emitting device.

Long-term reliability of the encapsulant becomes desirable as the life-span and emission of a LED lighting and the like is increased. Accordingly, it is desirable for an encapsulant for a high emission package to have high heat resistance, anti-crack properties, and the like.

Embodiments provide a curable polysiloxane composition having high crack resistance while maintaining high heat resistance and light resistance. Embodiments also provide an encapsulant obtained by curing the composition. Embodiments also provide an optical instrument including the encapsulant. For example, when the amide compound represented by Chemical Formula 1 is added to the curable composition of an organic polysiloxane having a T structure unit used in order to improve sulfur resistance, a high temperature modulus of the composition is remarkably decreased, and thus, an encapsulant obtained by curing the composition may have remarkably decreased cracks at a high temperature as well as improved sulfur resistance

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A curable organic polysiloxane composition, comprising:
an amide compound represented by Chemical Formula 1,
at least one first siloxane compound having a silicon-bonded alkenyl group and including a moiety represented by Chemical Formula 2, and
at least one second siloxane compound having a silicon-bonded hydrogen: 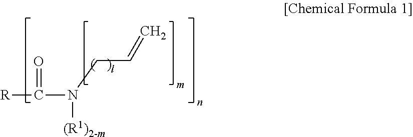
wherein, in Chemical Formula 1,
R is a saturated or unsaturated linear or branched C1 to C30 aliphatic hydrocarbon group, a substituted or unsubstituted C3 to C30 alicyclic hydrocarbon group, or a substituted or unsubstituted C6 to C30 aromatic organic group, the C6 to C30 aromatic organic group being an aromatic mono-ring, a condensed ring of two or more aromatic rings, a condensed ring of at least one aromatic ring and at least one aliphatic ring, at least one aromatic ring bonded with at least one aliphatic hydrocarbon group, or two or more aromatic rings linked by a functional group selected from a single bond, —O—, —C(═O)—, —NH—, or —S(═O)₂—,
R¹ is hydrogen or a C1 to C30 alkyl group,
l is an integer of 1 to 30,
m is 1 or 2, and
n is an integer of 1 to 30, 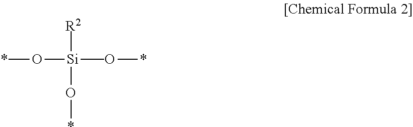
wherein, in Chemical Formula 2,
R² is a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted C2 to C30 alkynyl group, a substituted or unsubstituted C1 to C30 alkoxy group, a halogen, or a combination thereof.

2. The composition as claimed in claim 1, wherein, in Chemical Formula 1, R is a linear or branched C1 to C30 alkyl group, a C3 to C30 cycloalkyl group, a phenyl group, a naphthyl group, an anthracenyl group, a phenanthrenyl group, an indenyl group, an indanyl group, a biphenylene group, or an O,O-bisdiphenylene ether group.

3. The composition as claimed in claim 1, wherein, in Chemical Formula 1,1 is an integer of 1 to 10.

4. The composition as claimed in claim 1, wherein, in Chemical Formula 1,1 is 1.

5. The composition as claimed in claim 1, wherein, in Chemical Formula 1, m is 2.

6. The composition as claimed in claim 1, wherein, in Chemical Formula 1, n is an integer of 1 to 12.

7. The composition as claimed in claim 1, wherein the first siloxane compound is represented by Chemical Formula 3:
(R⁷R⁸R⁹SiO_{1/2})_{M1}(R¹⁰R¹¹SiO_{2/2})_{D3}(R¹²SiO_{3/2})_{T1}(SiO_{3/2}—Y³—SiO_{3/2})_{T2}(SiO_{4/2})_{Q1} [Chemical Formula 3]
wherein, in Chemical Formula 3,
R⁷ to R¹² are independently hydrogen, a hydroxy group, a halogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C3 to C30 heteroaryl group, a substituted or unsubstituted C2 to C30 alkenyl group, a substituted or unsubstituted C2 to C30 alkynyl group, a substituted or unsubstituted C1 to C30 alkoxy group, R²⁶(C═O)— (wherein R²⁶ is a substituted or unsubstituted C1 to C20 alkyl group, a substituted or unsubstituted C3 to C30 cycloalkyl group, a substituted or unsubstituted C6 to C30 aryl group, or a substituted or unsubstituted C7 to C30 arylalkyl group), or a combination thereof,
at least one of R⁷ to R¹² is a substituted or unsubstituted C2 to C30 alkenyl group,
Y³ is a single bond, a substituted or unsubstituted C1 to C20 alkylene group, a substituted or unsubstituted C3 to C20 cycloalkylene group, a substituted or unsubstituted C6 to C20 arylene group, a substituted or unsubstituted C2 to C20 heteroarylene group, a substituted or unsubstituted C2 to C20 alkenylene group, a substituted or unsubstituted C2 to C20 alkynylene group, or a combination thereof,
0<M1<1, 0≦D3<1, 0≦T1<1, 0≦T2<1, 0≦Q1<1, and
M1+D3+T1+T2+Q1=1.

8. The composition as claimed in claim 1, wherein the second siloxane compound is represented by Chemical Formula 4:
(R¹⁵R¹⁶R¹⁷SiO_{1/2})_{M2}(R¹⁸R¹⁹SiO_{2/2})_{D4}(R²⁰SiO_{3/2})_{T3}(SiO_{3/2}—Y⁴—SiO_{3/2})_{T4}(SiO_{4/2})_{Q2} [Chemical Formula 4]
wherein, in Chemical Formula 4,
R¹⁵ to R²⁰ are independently hydrogen, a hydroxy group, a halogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C3 to C30 heteroaryl group, a substituted or unsubstituted C2 to C30 alkenyl group, a substituted or unsubstituted C2 to C30 alkynyl group, a substituted or unsubstituted C1 to C30 alkoxy group, R²⁷(C═O)— (wherein R²⁷ is a substituted or unsubstituted C1 to C20 alkyl group, a substituted or unsubstituted C3 to C30 cycloalkyl group, a substituted or unsubstituted C6 to C30 aryl group, or a substituted or unsubstituted C7 to C30 arylalkyl group), or a combination thereof,
at least one of R¹⁵ to R²⁰ is hydrogen,
Y⁴ is a single bond, a substituted or unsubstituted C1 to C20 alkylene group, a substituted or unsubstituted C3 to C20 cycloalkylene group, a substituted or unsubstituted C6 to C20 arylene group, a substituted or unsubstituted C2 to C20 heteroarylene group, a substituted or unsubstituted C2 to C20 alkenylene group, a substituted or unsubstituted C2 to C20 alkynylene group, or a combination thereof,
0<M2<1, 0≦D4<1, 0≦T3<1, 0≦T4<1, 0≦Q2<1, and
M2+D4+T3+T4+Q2=1.

9. The composition as claimed in claim 7, wherein at least one of R⁷ to R¹² is a substituted or unsubstituted C6 to C30 aryl group.

10. The composition as claimed in claim 8, wherein at least one of R¹⁵ to R²⁰ is a substituted or unsubstituted C6 to C30 aryl group.

11. The composition as claimed in claim 1, wherein the amide compound represented by Chemical Formula 1 is included in an amount of about 5 wt % or less based on the total amount of the first siloxane compound and the second siloxane compound.

12. The composition as claimed in claim 1, wherein the amide compound represented by Chemical Formula 1 is included in an amount of about 0.1 wt % to about 5 wt % based on the total amount of the first siloxane compound and the second siloxane compound.

13. The composition as claimed in claim 1, wherein:
the first siloxane compound is included in an amount of greater than about 50 wt % based on the total amount of the first siloxane compound and the second siloxane compound, and
the second siloxane compound is included in an amount of less than about 50 wt % based on the total amount of the first siloxane compound and the second siloxane compound.

14. The composition as claimed in claim 1, wherein the amide compound represented by Chemical Formula 1 is one of the following compounds:

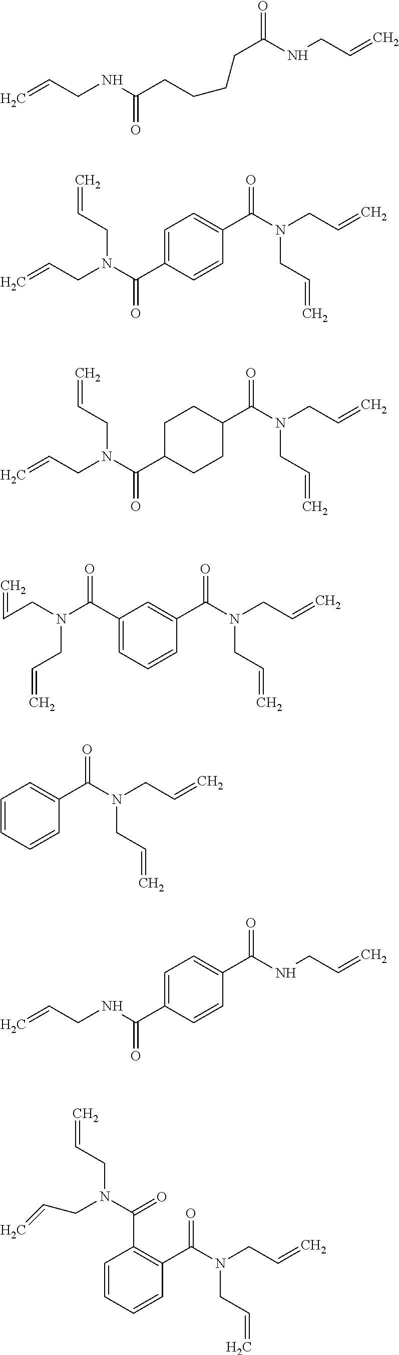

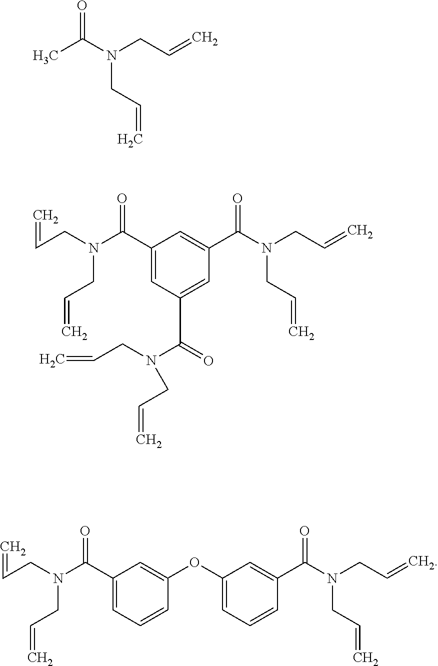

15. An encapsulant obtained by curing the composition as claimed in claim 1.

16. An electronic device including the encapsulant as claimed in claim 15.
